(19) United States
(12) Patent Application Publication
(10) Pub. No.: US 2006/0023590 A1
(43) Pub. Date: Feb. 2, 2006

(54) Optical disc recording method and information recording and reproducing apparatus

(76) Inventors: Toshiki Ishii, Tokyo (JP); Tsuyoshi Toda, Kodaira (JP); Masaaki Kurebayashi, Ebina (JP); Takakiyo Yasukawa, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/190,840

(22) Filed: Jul. 28, 2005

(30) Foreign Application Priority Data
Jul. 29, 2004 (JP) 2004-221044

(51) Int. Cl. G11B 19/00; G11B 7/12

(52) U.S. Cl. 369/47.5; 369/47.53; 369/53.1

(57) ABSTRACT

An optical disc recording and reproducing apparatus are provided in which even if a focusing error signal fluctuates suddenly by surface deflection or an obstacle such as scratch or dust on the surface of an optical disc, an effective recording laser power does not decrease but proper recording, erasure, and reproduction can be executed. An ordinary laser power for recording and a laser power for defocus, that is, a laser power larger than the ordinary recording laser power by a predetermined magnification are preset into a laser driver. In the normal case where a focusing error lies within a predetermined range, the former laser power is used. When the focusing error exceeds the predetermined range and the effective laser power is decreased by the defocus, the latter laser power is used.

### INCORPORATION BY REFERENCE

The present application claims priority from Japanese application JP2004-221044 filed on Jul. 29, 2004, the content of which is hereby incorporated by reference into this application.

### BACKGROUND OF THE INVENTION

The invention relates to an information recording and reproducing apparatus for recording or reproducing information to/from an information recording medium and, more particularly, to a technique for properly controlling a laser power in recording and reproduction to/from a medium such as a disc using an optical head.

In a paragraph [0004] of JP-A-6-12673 (pages 3-4, FIG. 1), the following problem has been mentioned: “Since an optical disc apparatus accesses an optical disc by optical means, if an obstacle such as dust, scratch, or the like which obstructs or deforms entrance of a laser beam exists on the surface of the optical disc, a defocus of the laser beam increases and a sudden fluctuation of a focusing error signal is caused according to circumstances. If such a signal fluctuation is too sudden, the focusing servo cannot accurately trace a recording track and the defocus of the laser beam increases locally, so that an effective output of the laser beam decreases and the recording, reproducing, or erasing operation cannot normally be executed. Thus, a data error occurs.”

As a method of solving such a problem, in a paragraph [0018] of JP-A-6-12673, the following method has been proposed: “Since the power of the laser beam is properly controlled in accordance with a fluctuation of the focusing error signal, even if the focusing error signal fluctuates suddenly due to the scratch or a foreign matter on the surface of the optical disc, the recording signal is hardly influenced by such a fluctuation but is always outputted with a stable amplitude of a predetermined level.” A similar technique has also been disclosed in JP-A-5-234119 (paragraphs [0034], [0035]).

### SUMMARY OF THE INVENTION

However, the optical disc apparatus disclosed in JP-A-6-12673 has the following problem: even if a fluctuation of a focusing error signal (hereinafter, referred to as an “FE signal”) as a signal indicative of a focusing error amount which is obtained from the reflection light of the optical disc is sudden and excessive, a reference power of the laser beam which changes in an analogwise manner is allowed to trace. Therefore, the reference power exceeding a limit of the laser is supplied to the laser and the laser is broken.

Although a construction in which the reference power of the laser is set on the basis of the FE signal which passed through a low pass filter in order to suppress the sudden fluctuation of the FE signal is also considered, there is a problem of delay in which the trackability of the laser reference power control deteriorates. That is, it is too late to switch the power to the proper laser power in spite of a fault area of the recording medium and, on the contrary, it is too late to return the laser power to an ordinary power in spite of a faultless area of the recording medium. Another problem in which a laser power correction amount/delay amount depends on a filter because it is processed in an analogwise manner also occurs.

Those problems further become problems which cannot be ignored in association with an increase in data recording speed when the data is recorded onto the optical disc.

It is, therefore, an object of the invention to solve those problems and provide an information recording method and an information recording and reproducing apparatus for compensating a lowering in effective laser power upon recording for a sudden fluctuation of a focusing error signal due to an obstacle or the like on a recording medium.

Another object of the invention is to provide an optical disc recording method which can provide strategy which can cope with different specifications of an optical disc.

To accomplish the above objects, it is a basic concept of the invention that, for the sudden and excessive fluctuation of the FE signal, the laser power is changed by a predetermined magnification without changing the reference power of the laser beam.

According to one aspect of the invention, an ordinary laser power for recording and a laser power upon defocusing, that is, a predetermined magnification of the ordinary laser power for recording are preliminarily set into a laser driver, when an FE signal is less than a predetermined threshold value, the ordinary laser power for recording is used, when the FE signal exceeds the predetermined threshold value, the laser power upon defocusing is used, and information is recorded.

According to another aspect of the invention, there is provided a method of recording information by irradiating a laser beam onto an information recording medium, comprising the steps of: setting a recording laser power to a fixed value P0 when a focusing error signal obtained from reflection light upon recording of the medium does not exceed a predetermined threshold value; setting the recording laser power to a value P1 larger than the P0 when the focusing error signal obtained from the reflection light upon recording of the medium exceeds the predetermined threshold value; and switching between the laser powers P0 and P1 in accordance with a detection result of the focusing error signal and recording the information.

According to another aspect of the invention, there is provided an information recording apparatus for irradiating a laser beam onto a recording area on an information recording medium and forming an area whose reflectance differs from that of a non-recording portion of information, thereby recording the information, comprising: a laser for irradiating the laser beam; detecting means for detecting a focusing error signal that is caused by a fluctuation in a focusing direction of the medium; and laser driving means for selecting a reference power as a laser driving power to be supplied to the laser from different set values in accordance with the focusing error signal detected by the detecting means and driving the laser.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of an optical disc recording and reproducing apparatus showing an embodiment of the invention;

FIGS. 2A to 2C are diagrams showing an FE signal and a reproduction waveform;

FIGS. 3A to 3C are diagrams showing power control upon recording in the first embodiment; and

FIGS. 4A to 4C are diagrams showing power control upon recording in the second embodiment.

### DESCRIPTION OF THE EMBODIMENTS

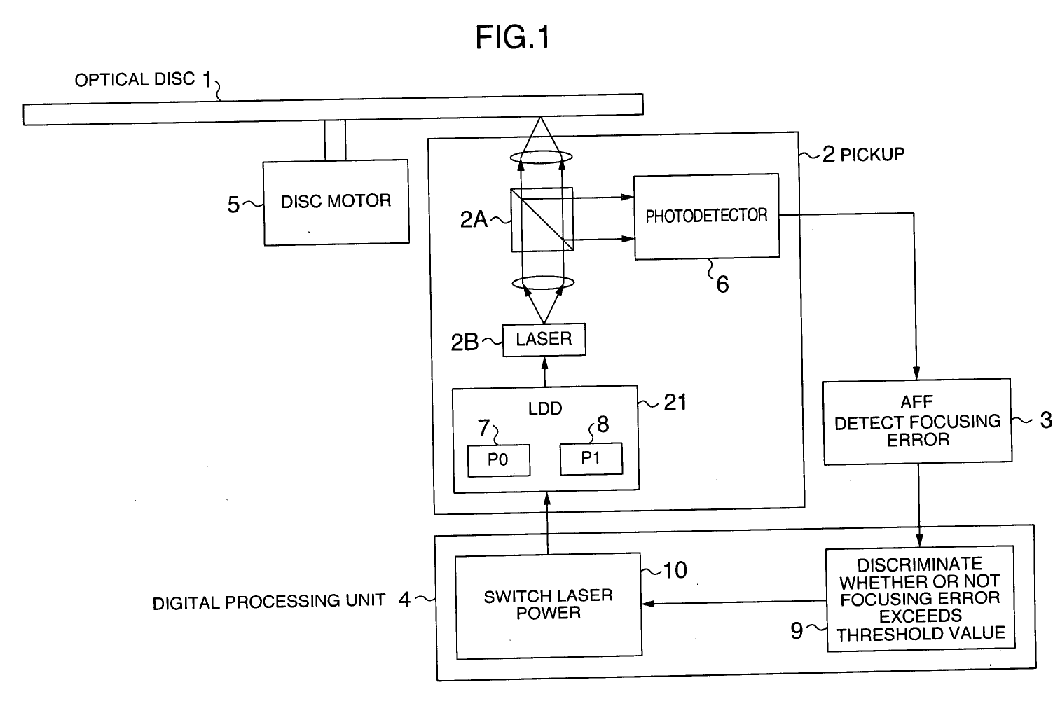

An optical disc recording and reproducing apparatus of the first embodiment will be described with reference to a block diagram of FIG. 1. In FIG. 1, reference numeral l denotes an optical disc; 2 an optical pickup for irradiating a laser onto the optical disc 1 and recording and reproducing; 3 an analog front end (hereinafter, abbreviated to “AFE”) for executing an analog process of an output signal of the pickup 2; 4 a digital processing unit (hereinafter, abbreviated to “DSP” (digital signal processor)) for executing a digital process to an output signal of the AFE 3; and 5 a disc motor for rotating the optical disc 1.

The pickup 2 includes: a photodetector 6 for converting a laser beam emitted from a pickup unit 2A of an optical system into an electric signal; a laser 2B; and a laser driver LDD 21 for driving the laser 2B. Further, the DSP 4 includes: a discriminating circuit 9 for discriminating whether or not a focusing error exceeds a threshold value; and a switching instructing circuit 10 for instructing switching of a laser power in response to an output of the discriminating circuit. Reference numerals 7 and 8 denote setting units of different reference laser power values P0 and P1 which are set into the LDD 21, respectively.

The two or more laser power set values P0 and P1 have been preset in the laser driver 21 mounted on the optical pickup 2. The laser powers which are set here can be switched by the DSP 4.

An FE signal which is formed from reflection light of the optical disc 1 upon recording of data is inputted to the DSP 4 through the optical pickup 2 and the AFE 3. The DSP 4 makes focusing control on the basis of the FE signal.

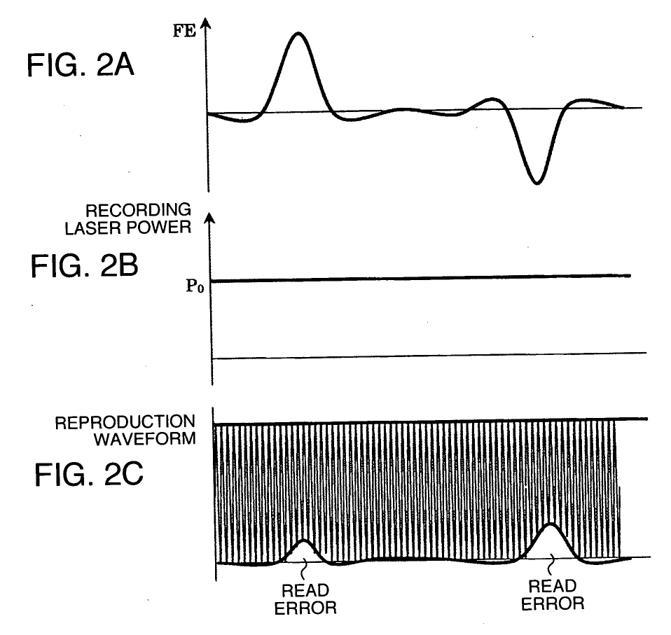

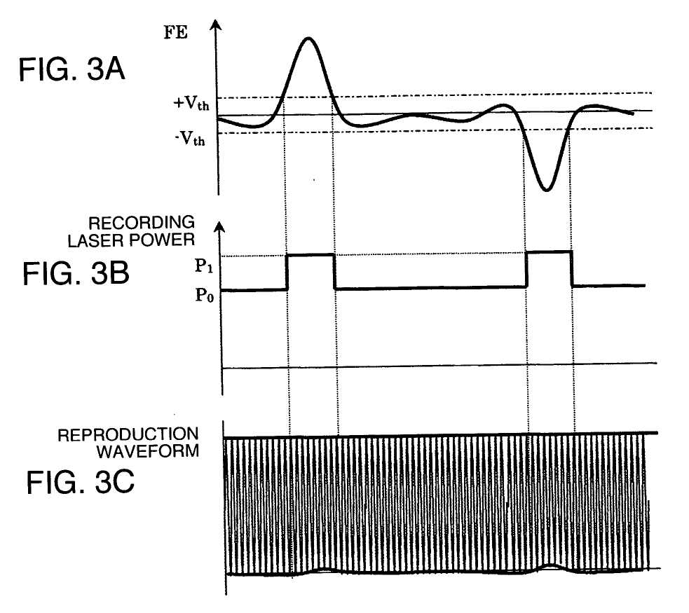

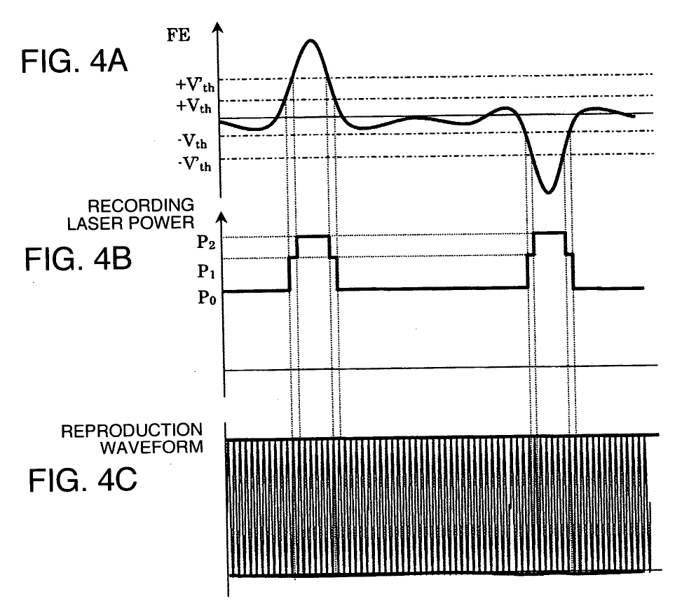

A relation between the FE signal obtained upon recording and a reproduction waveform obtained when the recorded data is reproduced will be described with reference to FIGS. 2A to 2C. In FIG. 2A (and FIGS. 3A and 4A, which will be explained hereinafter), it is assumed that when the FE signal is at the 0 level, this means that it is at a reference level which is set in consideration of surface deflection of the optical disc and the pickup exists in a focusing position that is optimum to the recording and reproduction. A reference level which is set in consideration of a fluctuation in the surface deflection direction denotes a reference level which offsets a fluctuation of the focusing error signal. The fluctuation in the surface deflection direction denotes a fluctuation in the direction perpendicular to the disc surface of the focusing error signal.

When the FE signal changes suddenly, a focusing servo cannot trace such a change and defocus occurs (FIG. 2A). However, by using control for setting the laser power to be constant irrespective of the FE signal (FIG. 2B), the effective laser power on the disc film surface decreases in this portion. That is, the portion where the FE signal changes suddenly enters a recording state that is equivalent to the state where the data has been recorded by a weak laser power. Therefore, an amplitude of a reproduction waveform obtained when this portion is reproduced decreases and a possibility of occurrence of a read error rises (FIG. 2C).

In the embodiment, therefore, the laser power is switched on the basis of the FE signal inputted to the DSP 4. Explanation will be made in detail with reference to FIGS. 3A to 3C.

First, detection threshold values ±Vth are set for the FE signal and an absolute value of the FE signal is compared with Vth (FIG. 3A). When the absolute value of the FE signal is smaller than Vth, the ordinary power P0 of the LDD 21 is validated by the DSP 4. When the absolute value of the FE signal is larger than Vth, that is, when the defocus is large and the effective power on the disc film surface decreases, the power P1 (for example, P1=P0×1.1) larger than the ordinary power P0 is set into the LDD 21 by the DSP 4 (FIG. 3B). Thus, the data can be recorded at desired recording quality by controlling so as to increase the laser power in the portion where the focusing error changed suddenly. Thus, when the data is reproduced, the good amplitude of the reproduction signal can be obtained and the read error can be prevented (FIG. 3C). Although the detection threshold value of the plus side and the detection threshold value of the minus side are set to the same value, they can be individually set in accordance with, for example, characteristics of the apparatus.

According to the construction of the embodiment, the laser breakdown due to the applying of the excessive power can be prevented by using the method of switching the laser power in accordance with the fluctuation of the FE signal. It is also possible to avoid such a meaningless recording operation that the laser power is raised to a value larger than a necessary power and the recording is tried to the area where the recording cannot be normally executed due to the presence of a scratch or the like. Further, since the simple method of switching the laser power on the basis of the result of the discrimination about whether or not the FE signal exceeds the predetermined threshold value is used, the trackability for the fluctuation of the FE signal can be also improved. That is, it is possible to avoid such a problem that the recording is tried to the fault area by the laser beam of the insufficient power or such a problem that the recording is tried to the faultless area by the laser beam of the excessive power.

Consequently, the recording quality can be improved, so that the reliability of the information reproduction can be raised.

Since the simple method of switching the laser power on the basis of the result of the discrimination about whether or not the FE signal exceeds the predetermined threshold value is used, the construction of the laser control circuit can be simplified.

The second embodiment will now be described with reference to FIG. 4. Since a construction of an optical disc apparatus in the second embodiment is similar to that of the optical disc apparatus in the first embodiment, its detailed explanation is omitted here.

The embodiment has a feature that a plurality of detection threshold values of the FE signal are provided (FIG. 4A). In a manner similar to the first embodiment, the DSP 4 sets the power P1 (for example, P1=P0×1.1) into the LDD 21 when the FE signal exceeds Vth as a first detection threshold value. When the FE signal exceeds a detection threshold value V'th as a second detection threshold value, the DSP 4 sets a power P2 (for example, P2=P0×1.2) into the LDD 21, thereby enabling a finer laser power to be set in accordance with the fluctuation of the FE signal (FIG. 4B).

According to the embodiment, in addition to the effect obtained by the first embodiment, such an effect that the data of higher quality can be recorded and the reproduction waveform of higher quality can be obtained (FIG. 4C).

Although the first and second embodiments have been described above on the assumption that the power P1=P0×1.1 and the power P2=P0×1.2, the invention is not limited to such an example. Naturally, they can be also properly set every optical disc information recording and reproducing apparatus or every optical disc.

An example in which the embodiment is applied to a DVD recording and reproducing apparatus will now be shown. A focus deviation frequency is equal to about 2 kHz (DVD 16×) and various specifications are as follows. (× denotes a times-speed). A laser wavelength is equal to 640±15 nm, a track pitch is equal to 0.74 μm, a 3T pitch length is equal to 0.400 μm for a single layer, a linear velocity is set to 3.49 m/sec (1×) and 55.84 m/sec (16×), and a channel data rate is set to 26.16 Mbps (1×) and 418.6 Mbps (16×).

According to the invention, even if a scratch or the like exists on the surface of the optical disc, the reliability of the recording signal can be improved.

It should be further understood by those skilled in the art that although the foregoing description has been made on embodiments of the invention, the invention is not limited thereto and various changes and modifications may be made without departing from the spirit of the invention and the scope of the appended claims.

1. An information recording method of irradiating a laser beam onto a recording area on an information recording medium and forming an area whose reflectance differs from that of a non-recording portion of information, thereby recording the information, comprising the steps of:
detecting a focusing error signal indicative of a focusing error amount from reflection light obtained upon recording of the information; and
switching a reference power as a power to drive a laser to a reference power different from the first-mentioned reference power on the basis of the detected focusing error signal.

2. A method according to claim 1, wherein when the focusing error signal exceeding a predetermined threshold value, than a reference level which offsets a fluctuation in a surface deflecting direction of said information recording medium is detected, said reference power is switched.

3. A method according to claim 2, wherein said reference power is switched by changing the reference power by a predetermined magnification.

4. An information recording method of irradiating a laser beam onto a recording area on an information recording medium and forming an area whose reflectance differs from that of a non-recording portion of information, thereby recording the information, comprising the steps of:
detecting a focusing error signal indicative of a focusing error amount from reflection light obtained upon recording of the information; and
switching an output power of the laser beam to a corresponding set value on the basis of the detected focusing error signal.

5. A method according to claim 4, wherein when the focusing error signal that is larger, by a predetermined value, than a reference level which offsets a fluctuation in a surface deflecting direction of said information recording medium is detected, said output power is switched.

6. A method according to claim 5, wherein said output power is switched by changing the output power by a predetermined magnification.

7. An information recording method of recording information by irradiating a laser beam onto an information recording medium, comprising the steps of:
detecting that a focusing error signal obtained from reflection light upon recording of said information recording medium exceeds a predetermined threshold value; and
switching a recording laser power from a fixed value P0 to a fixed value P1 in response to said detection.

8. An information recording method of recording information by irradiating a laser beam onto an information recording medium, comprising the steps of:
setting a recording laser power to a fixed value P0 in response to detection of a focusing error signal obtained from reflection light upon recording of said information recording medium and not exceeding a predetermined threshold value;
setting the recording laser power to a fixed value P1 larger than said P0 in response to detection of the focusing error signal obtained from the reflection light upon recording of said information recording medium and exceeding the predetermined threshold value; and
recording the information by using said P0 or P1.

9. An information recording apparatus for irradiating a laser beam onto a recording area on an information recording medium and forming an area whose reflectance differs from that of a non-recording portion of information, thereby recording the information, comprising:
a laser for irradiating the laser beam;
detecting means for detecting a focusing error signal that is caused by a fluctuation in a focusing direction of said information recording medium;
power control means for switching a reference power which is supplied to said laser or an output power of said laser beam on the basis of the focusing error signal detected by said detecting means; and
means for recording or reproducing the information by driving a laser with the reference power or the output power switched with said power control means.

10. An information recording and reproducing apparatus for irradiating a laser beam onto a recording area on an information recording medium and forming an area whose reflectance differs from that of a non-recording portion of information to thereby record the information, comprising:
a laser which irradiates the laser beam;
a detector which detects a focusing error signal that is caused by a fluctuation in a focusing direction of said information recording medium;
a power control unit which supplies a recording laser power as a fixed value P0 when the focusing error signal detected by said detector does not exceed a predetermined threshold value and supplying the recording laser power as a fixed value P1 larger than said P0 when said focusing error signal exceeds the predetermined threshold value; and
an apparatus which records or reproduces the information by said supplied laser power.
